(19) United States
(12) Patent Application Publication
(10) Pub. No.: US 2008/0303793 A1
(43) Pub. Date: Dec. 11, 2008

(54) On-screen keyboard

(75) Inventor: Simon Carroll, Mountain View, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/810,421

(22) Filed: Jun. 5, 2007

(51) Int. Cl. G06F 3/02

(52) U.S. Cl. 345/168

(57) ABSTRACT

Embodiments of an on-screen keyboard are described. In embodiment(s), a display of an on-screen keyboard can include letters arranged for user selection based on a frequency of the letters that are used most often. The letters can be of an alphabet for a language where the letters are arranged in the on-screen keyboard based on the frequency of the letters that appear most often in words of the language. User inputs can be received via an input device to navigate the on-screen keyboard and position a focus to select the letters for on-screen text entry.

### BACKGROUND

For an interactive gaming or television system, a television remote control may be the only input device by which a user can interact with an electronic application to enter selectable characters or alphanumeric inputs. Television remote controls can be difficult to use as text input devices, particularly due to the limited set of input keys that are available on such devices. For example, other than the various configuration and television-specific input keys, a television remote control may only have a standard numeric or alphanumeric input keypad. A viewer can not easily input letters for a text entry, such as to search in an electronic program guide for specific media content, or easily enter other alphabet characters and words for the requested information to setup a video game.

Other various electronic applications may also be available for interaction through a television system via a cable provider or other television system content provider. On-screen QWERTY keyboards that are provided for interaction with the various electronic applications are also inefficient when using a television remote control device to interact with the user interfaces of the electronic applications, such as a video game, television program guide, or other graphical user interface. For example, a user has to navigate up and down, or back and forth, across the on-screen QWERTY keyboard to enter alphabet characters to interact with the user interfaces of the various electronic applications.

### SUMMARY

This summary is provided to introduce simplified concepts of an on-screen keyboard. The simplified concepts are further described below in the Detailed Description. This summary is not intended to identify essential features of the claimed subject matter, nor is it intended for use in determining the scope of the claimed subject matter.

In embodiment(s), a display of an on-screen keyboard can include letters arranged for user selection based on a frequency of the letters that are used most often. The letters can be of an alphabet for a language where the letters are arranged in the on-screen keyboard based on the frequency of the letters that appear most often in words of the language. Alternatively, the letters can be of words used in a profession, such as the medical field, where the letters are arranged for user selection based on the frequency of the letters that appear most often in the words of the profession. User inputs can be received via an input device to navigate an on-screen keyboard and position a focus to select the letters for on-screen text entry.

### BRIEF DESCRIPTION OF THE DRAWINGS

Embodiments of an on-screen keyboard are described with reference to the following drawings. The same numbers are used throughout the drawings to reference like features and components:

FIG. 1 illustrates an example system in which embodiments of an on-screen keyboard can be implemented.

FIG. 2 illustrates another example system in which embodiments of an on-screen keyboard can be implemented.

FIG. 3 illustrates another example system in which embodiments of an on-screen keyboard can be implemented.

FIG. 4 illustrates example method(s) for an on-screen keyboard in accordance with one or more embodiments.

FIG. 5 illustrates various components of an example computer device which can implement embodiments of an on-screen keyboard.

### DETAILED DESCRIPTION

Embodiments of an on-screen keyboard provide a keyboard on a graphical user interface that includes letters arranged based on a frequency of the letters that are used most often to minimize the number of inputs needed when entering on-screen text in the user interface. For example, an on-screen keyboard can include letters of an alphabet for a language where the letters are arranged for user selection based on a frequency of the letters that appear most often in words of the language. A user can easily navigate the on-screen keyboard to select the most frequently used letters when entering the on-screen text.

While features and concepts of the described systems and methods for an on-screen keyboard can be implemented in any number of different environments, computing or gaming systems, and/or other various configurations, embodiments of an on-screen keyboard are described in the context of the following example systems and environments.

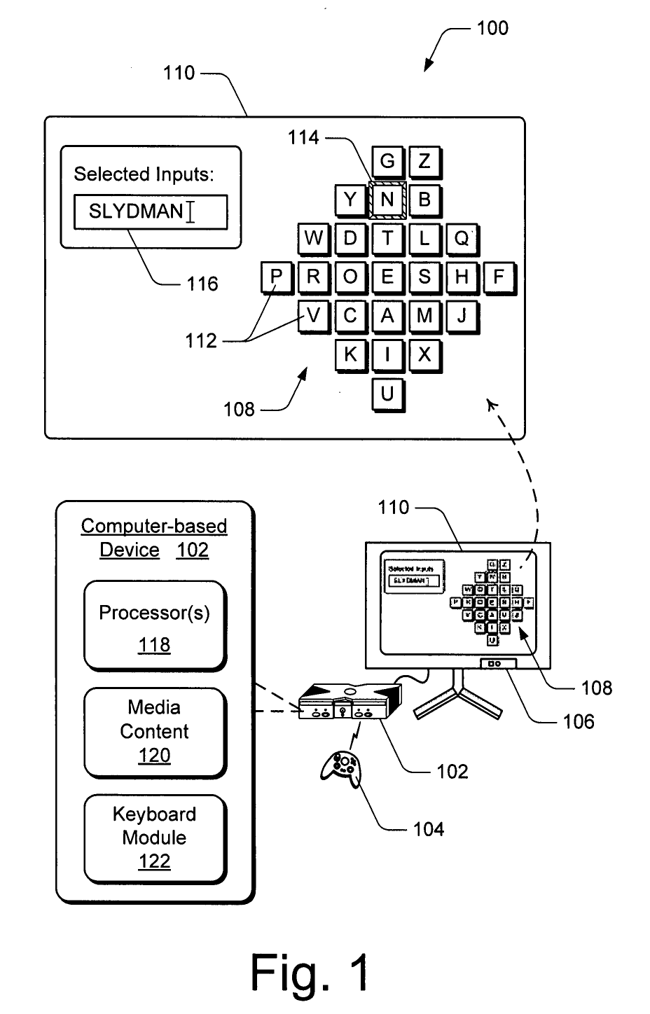

FIG. 1 illustrates an example system 100 in which various embodiments of an on-screen keyboard can be implemented. In this example, system 100 includes a computer-based device 102 which is shown as a gaming system having a game controller 104 for user interaction with the gaming system. The example system 100 also includes a display device 106 having an on-screen keyboard 108 displayed on a graphical user interface 110. The on-screen keyboard 108 includes letters 112 arranged for user selection based on a frequency of the letters that are used most often.

In an embodiment, the on-screen keyboard 108 includes the letters of an alphabet for a language, and the letters are arranged for user selection based on the frequency of the letters that appear most often in words of the language. In this example, the most frequently used letter in the English alphabet is “E” which is positioned at the center of the on-screen keyboard 108. The more frequently used letters are arranged or positioned closer to the center of the on-screen keyboard 108, and the less frequently used letters are positioned further from the center of the keyboard. In another implementation, the most frequently used letter in Brazil is “A” as based on the Portuguese alphabet. For an implementation of an on-screen keyboard in Brazil, the letter “A” can be positioned at the center of the keyboard.

A determination of the most frequently used letters of an alphabet can vary depending on the source of the words used to determine the frequency. The informational Web site “AskOxford” describes that the inventor of Morse code, Samuel Morse, needed to determine the frequency of the letters in the English alphabet so that he could give the simplest codes to the most frequently used letters. He determined the frequency of the letters by counting the number of letters in sets of printers' type and found that the letters “E”, “T”, “A”, “I”, “N”, “O”, and “S” were used the most.

As shown in the example on-screen keyboard 108, the most frequently used letter “E” is positioned at the center of the keyboard, and the other most frequent letters are arranged around the center letter. Although the letter “R” is not included in the list of most used letters determined from the sets of printers' type, the Web site “AskOxford” describes that “R” is the third most used letter based on the letters occurring in the words listed in the main entries of the Concise Oxford Dictionary (9th edition, 1995). Any resources similar to these mentioned can be utilized to determine the most frequently used letters of an alphabet so that the more frequently used letters can be positioned closer to the center of an on-screen keyboard.

In another embodiment, the on-screen keyboard 108 can include the letters of words used in a profession, such as the medical field. The letters can be arranged in the on-screen keyboard for user selection based on the frequency of the letters that appear most often in the words of the profession. For example, an on-screen keyboard for doctors may be implemented for the letters that appear most frequently in the words used to write out prescriptions for medication. A doctor may use a hand-held portable device with an on-screen keyboard to prepare prescriptions for patients.

In the example system 100, a user can navigate the on-screen keyboard 108 with user inputs via the game controller 104 and position a focus 114 to select letters for on-screen text entry. A selected inputs field 116 on the graphical user interface 110 shows the selected letters of a text entry. In this example, a user may enter an on-line name for gaming and has entered the name “SLYDMAN” by navigating the focus 114 up and down and/or right and left over the letters in the on-screen keyboard 108 to select the letters of the name. The on-screen keyboard 108 is also efficient to use when entering all of the setup information for a gaming system and/or for a new game.

As an example for comparison, to enter the name “SLYDMAN” with an on-screen QWERTY keyboard, a user would start at “S” and then have an additional thirty-three (33) inputs to navigate and spell out the name: “S” over to “L” is seven (7) inputs; “L” to “Y” is up one (1) and over three (3); “Y” to “D” is over three (3) and down (1); “D” to “M” is over four (4) and down one (1); “M” to “A” is back six (6) and up one (1); and finally “A” to “N” is down one (1) and over five (5) for the total of thirty-three (33) navigation inputs plus another seven (7) inputs to select the letters.

To enter the name “SLYDMAN” utilizing the on-screen keyboard 108, a user would start at “S” and have only an additional thirteen (13) inputs to navigate and spell out the name: “S” up to “L” is one (1) input; “L” to “Y” is up one (1) and over two (2); “Y” down to “D” is one (1) input; “D” to “M” is over two (2) and down (2); “M” over to “A” is just one (1) input; and “A” up to “N” is three (3) inputs for the total of thirteen (13) navigation inputs (plus the seven (7) inputs to select the letters). The on-screen keyboard 108 minimizes the number of navigation inputs needed to enter text by having the more frequently used letters arranged closer to the center of the keyboard.

In another embodiment, the focus 114 can be automatically repositioned after a letter has been selected back to the most frequently used letter in the on-screen keyboard 108 (which is the letter “E” at the center of the keyboard in this example). This further minimizes the number of navigation inputs needed to navigate the on-screen keyboard 108 and enter text. For example, to enter the name “SLYDMAN” utilizing the on-screen keyboard 108 with the focus 114 being repositioned back to the center of the keyboard after a letter has been selected, a user would start at “S” and have only an additional twelve (12) inputs to navigate and spell out the name: “E” to “L” is two (2) inputs; “E” to “Y” is three (3) inputs; “E” to “D” is two (2) inputs; “E” to “M” is two (2) inputs; “E” down to “A” is one (1) input; and “E” up to “N” is two (2) inputs for the total twelve (12) navigation inputs.

In another embodiment, a time delay (optionally user configurable) can be implemented between successive user inputs to select the same letter twice, to move the focus to select another letter, or to reposition the focus back to the most frequently used letter in the center of the on-screen keyboard 108. For example, a user can select a letter and rather than the focus being automatically repositioned back to the center letter, the user can move the focus within the time delay period to another letter such that the focus does not reposition. This embodiment also minimizes the number of navigation inputs needed to navigate the on-screen keyboard 108 and enter text.

For example, to enter the name “SLYDMAN” utilizing the on-screen keyboard 108 with a reposition time delay of the focus 114 after a letter has been selected, a user would start at “S” and have only an additional ten (10) inputs to navigate and spell out the name: “S” up to “L” is one (1) input; “L” to “Y” is three (3) inputs; “Y” down to “D” is one (1) input; then after the time delay to reposition the focus, “E” to “M” is two (2) inputs; “M” over to “A” is just one (1) input; and then after another time delay, “E” up to “N” is two (2) inputs for the total of ten (10) navigation inputs.

Utilizing the game controller 104 to select letters for on-screen text entry from the on-screen keyboard 108 may also provide an alternate embodiment to the described, optional time delay. The game controller 104 may be implemented with an analog stick (e.g., an “input device”) to position a visual cursor or arrow (e.g., the focus 114) over the letters on the keyboard. The position of the analog stick, as manipulated by a user, relates to where the visual cursor or arrow is positioned on the keyboard 108, such as over a letter to be selected. When a letter is selected, and the analog stick is released or let go of by the user, it returns to a rest position on the game controller and the visual cursor or arrow would snap back to the center of the keyboard. In this implementation, the position of the visual cursor or arrow on the on-screen keyboard 108 reflects the position of the analog stick on the game controller 104.

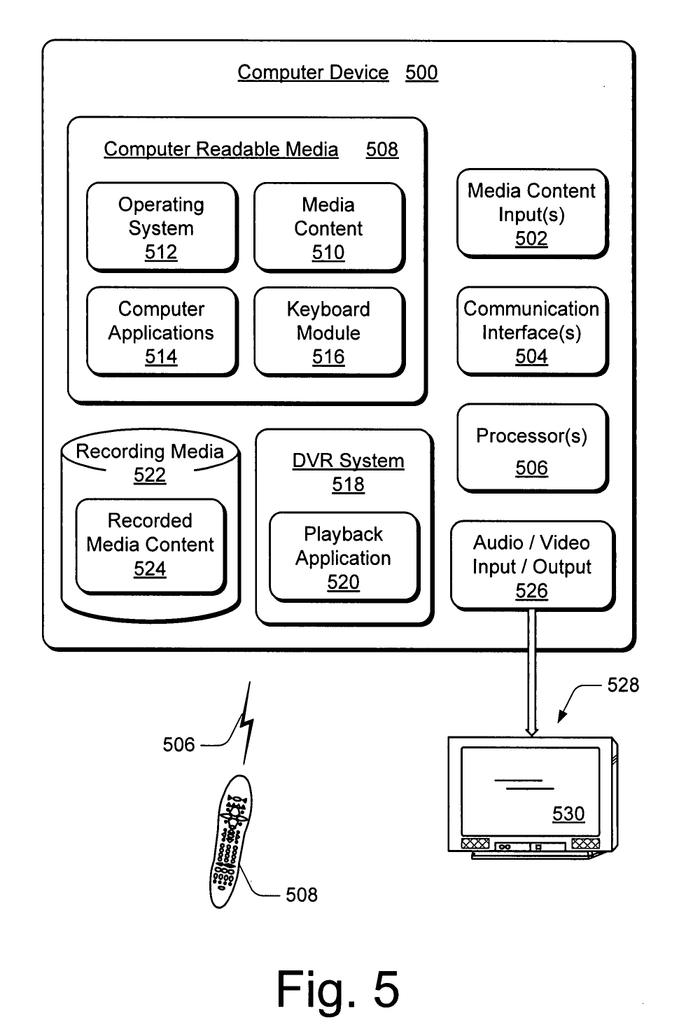

The computer-based device 102 can be implemented as any one or combination of a computer, television client device, gaming console, a portable device such as a PDA cell phone, and/or as any other type of electronic appliance, and/or computing-based device. Additionally, the computer-based device 102 can be implemented with any number and combination of differing components as further described with reference to the example computer device shown in FIG. 5.

In this example system 100, the computer-based device 102 includes one or more processor(s) 118 and media content 120, such as a gaming application or any other audio, video, and/or image content. The computer-based device 102 also includes a keyboard module 122 that can be implemented as computer-executable instructions and executed by the processor(s) 118 to implement embodiments of an on-screen keyboard. Although the keyboard module 122 is illustrated and described as an independent module, the keyboard module 122 can be implemented as several component applications or modules distributed to perform one or more functions of an on-screen keyboard.

In various embodiments, the keyboard module 122 can be implemented to generate the on-screen keyboard 108 for display on the graphical user interface 110. The keyboard module 122 can also be implemented to initiate the time delay between successive user inputs to allow for selecting the same letter twice or for moving the focus 114 to select another letter. The keyboard module 122 can also be implemented to reposition the focus 114 back to the most frequently used letter in the center of the on-screen keyboard 108 after a letter has been selected, or to position the focus 114 on a next most likely letter in the keyboard after a letter has been selected.

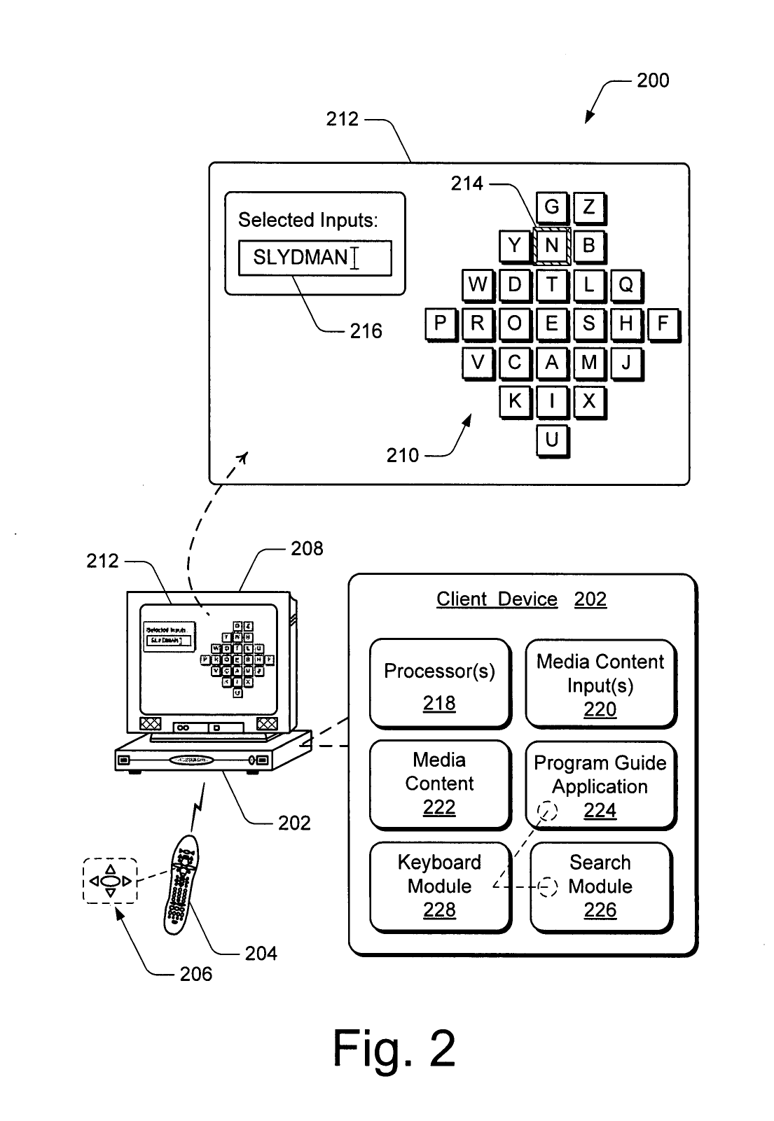

FIG. 2 illustrates another example system 200 in which various embodiments of an on-screen keyboard can be implemented. The system 200 includes a television client device 202 and a remote control device 204 that has selectable controls 206 for user interaction with the client device. System 200 also includes a display device 208 having an on-screen keyboard 210 displayed on a graphical user interface 212. As described with reference to the on-screen keyboard 108 shown in FIG. 1, the on-screen keyboard 210 is implemented to include letters arranged for user selection based on a frequency of the letters that are used most often.

In the example system 200, a user can navigate the on-screen keyboard 210 with user inputs via the selectable controls 206 of the remote control device 204 and position a focus 214 to select letters for on-screen text entry. A selected inputs field 216 on the graphical user interface 212 shows the selected letters of a text entry. In this example, a user may enter a movie title to search for the movie, and has entered the movie title “SLYDMAN” by navigating the focus 214 up and down and/or right and left over the letters in the on-screen keyboard 210 to select the letters of the movie title. The on-screen keyboard 210 is efficient to use when searching for programs, movies, and other viewing options, and when interacting with on-line applications.

In this example system 200, the television client device 202 includes one or more processor(s) 218, media content inputs 220, and media content 222 (e.g., received media content or media content that is being received). The media content inputs 220 can include any type of communication interfaces and/or data inputs, such as Internet Protocol (IP) inputs over which streams of media content (e.g., IPTV media content) are received. Client device 202 can receive the media content 222 from any number of media content resources, such as from a content distributor via an IP-based network that is implemented as part of a system communication network. Additionally, the television client device 202 can be implemented with any number and combination of differing components as further described with reference to the example device shown in FIG. 5.

The media content 222 can include television programs (or programming) which may be any form of programs, commercials, music, movies, and video on-demand media content. Other media content can include interactive games, network-based applications, music streamed to the client device 202, as well as any other audio, video, and/or image content received from any type of media content source.

Client device 202 includes a program guide application 224 that processes program guide data from which a program guide can be rendered and displayed for viewing on display device 208. Additionally, client device 202 can include a search module 226 or application that can be implemented to receive a search request for television media content when initiated by a viewer. The client device 202 also includes a keyboard module 228 that implements embodiments of an on-screen keyboard as described with reference to the keyboard module 122 shown in FIG. 1. The program guide application 224, search module 226, and keyboard module 228 can each be implemented as computer-executable instructions and executed by the processor(s) 218 to implement embodiments of an on-screen keyboard. Additionally, the keyboard module 228 may be implemented as an independent component, or as a component of either the program guide application 224 or the search module 226 to implement embodiments of an on-screen keyboard.

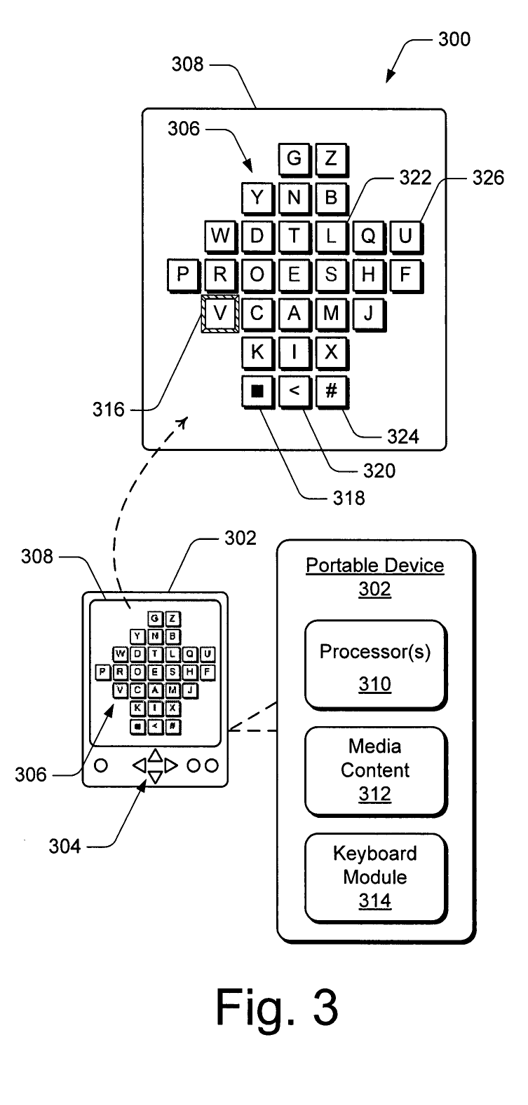

FIG. 3 illustrates another example system 300 in which various embodiments of an on-screen keyboard can be implemented. The system 300 includes a portable device 302 that has selectable controls 304 for user interaction with an on-screen keyboard 306 displayed on a graphical user interface 308 of the portable device. In this example, the portable device 302 includes one or more processor(s) 310 and media content 312, such as any other audio, video, and/or image content.

The portable device 302 also includes a keyboard module 314 that implements embodiments of an on-screen keyboard, such as described with reference to the keyboard module 122 shown in FIG. 1. The keyboard module 314 can be implemented as computer-executable instructions and executed by the processor(s) 310 to implement embodiments of an on-screen keyboard. Additionally, the portable device 302 can be implemented with any number and combination of differing components as further described with reference to the example device shown in FIG. 5.

In the example system 300, a user can navigate the on-screen keyboard 306 with user inputs via the selectable controls 304 of the portable device 302 and position a focus 316 to select letters for text entry. A user may select letters from the on-screen keyboard 306 by navigating the focus 316 up and down and/or right and left over the letters in the on-screen keyboard 306.

In various embodiments, an on-screen keyboard can include extra keys or user-selectable controls that facilitate on-screen text entry. For example, the on-screen keyboard 306 includes a “done” or “stop” selectable control 318 that can be selected by a user to indicate that a particular word or phrase has been entered and/or to initiate a search or some other action corresponding to the entered text. As another example, the on-screen keyboard 306 includes a “backspace” selectable control 320 that can be selected by a user to backspace over entered text or to move back and insert a letter in a word or phrase. Although only these two examples of user-selectable controls 318 and 320 are described, any form of user-selectable controls can be implemented in an on-screen keyboard to facilitate on-screen text entry.

An on-screen keyboard can also be implemented such that some of the letters are “grayed-out” or otherwise indicated as being not selectable based on letters that have already been selected and based on known words or phrases that can be searched. For example, the media content 312 may include a list of words, movie titles, song titles, and/or any other form of searchable media content. When a user begins entering letters to form a word text entry, the letters 322 that would no longer be selectable to complete the word entry can be indicated as not being selectable. In this example, the letters 322 are “grayed-out” to indicate that they are not selectable. However, any form of indication can be implemented to indicate the selectable status of particular letters in an on-screen keyboard.

An on-screen keyboard can also be implemented to include numbers arranged for user selection based on a frequency of the numbers that are used most often. In an embodiment, an on-screen keyboard can be implemented as an alphanumeric keyboard that includes both letters and numbers. Alternatively, an on-screen keyboard can be implemented to include just the numbers arranged for user selection based on a frequency of the numbers that are used most often. For example, a numeric on-screen keyboard may include any of the numbers “0”, “1”, or “8” as the center number and/or numbers that are positioned near the center of the keyboard, depending upon a determination as to which number is the most frequently used. The example on-screen keyboard 306 includes a user-selectable number 324 that may be any number, or that can be selected to initiate a display of a numeric on-screen keyboard that includes the numbers for selection.

An on-screen keyboard can also be implemented for optional user configuration. For example, a user may reposition letters in the on-screen keyboard 306 to facilitate entering on-screen text more efficiently for a particular application. In this example, the letter “U” has been repositioned at 326 (from the bottom of on-screen keyboard 210 shown in FIG. 2) next to “Q” because “U” is often selected after “Q” when entering text in English language words.

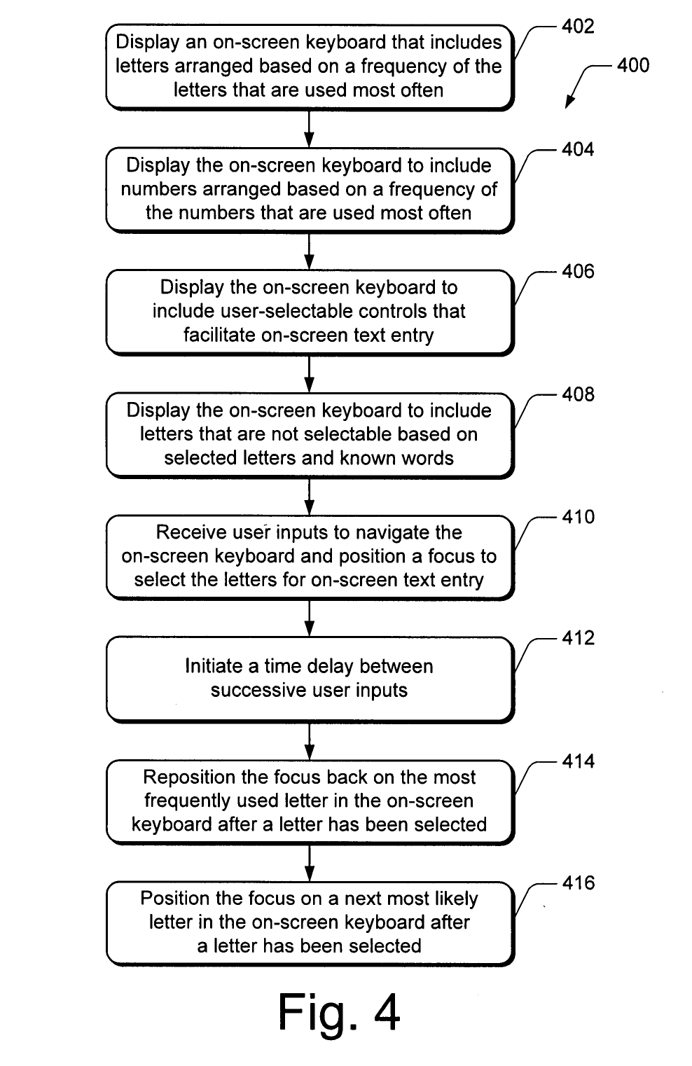

Generally, any of the functions, methods, and modules described herein can be implemented using hardware, software, firmware (e.g., fixed logic circuitry), manual processing, or any combination thereof. A software implementation of a function, method, or module represents program code that performs specified tasks when executed on a computing-based processor. Example method 400 described with reference to FIG. 4 may be described in the general context of computer-executable instructions. Generally, computer-executable instructions can include applications, routines, programs, objects, components, data structures, procedures, modules, functions, and the like that perform particular functions or implement particular abstract data types.

The method(s) may also be practiced in a distributed computing environment where functions are performed by remote processing devices that are linked through a communications network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 4 illustrates example method(s) 400 for various embodiment(s) of an on-screen keyboard. The order in which the method is described is not intended to be construed as a limitation, and any number of the described method blocks can be combined in any order to implement the method, or an alternate method.

At block 402, an on-screen keyboard is displayed that includes letters arranged based on a frequency of the letters that are used most often. For example, on-screen keyboard 108 (FIG. 1) is displayed on graphical user interface 110 and includes letters 112 arranged for user selection based on a frequency of the letters that are used most often. In an embodiment, the letters are an alphabet for a language and the letters are arranged based on the frequency of the letters that appear most often in words of the language. In another embodiment, the letters are for words used in a profession and the letters are arranged based on the frequency of the letters that appear most often in the words of the profession.

Optionally at block 404, the on-screen keyboard is displayed to include numbers arranged based on a frequency of the numbers that are used most often. For example, on-screen keyboard 306 (FIG. 3) includes a user-selectable number 324 that may be any number, or that can be selected to initiate a display of a numeric on-screen keyboard that includes numbers for selection.

Optionally at block 406, the on-screen keyboard is displayed to include user-selectable controls that facilitate on-screen text entry. For example, on-screen keyboard 306 includes a “done” or “stop” selectable control 318 that can be selected by a user to indicate that a particular word or phrase has been entered and/or to initiate a search or some other action corresponding to the entered text. The on-screen keyboard 306 also includes a “backspace” selectable control 320 that can be selected by a user to backspace over entered text or to move back and insert a letter in a word or phrase. Although only these two examples of user-selectable controls 318 and 320 are described, any form of user-selectable controls can be implemented in an on-screen keyboard to facilitate on-screen text entry.

Optionally at block 408, the on-screen keyboard is displayed to include letters that are not selectable based on one or more selected letters and known words. For example, when a user begins entering letters to form a word text entry, the letters in an on-screen keyboard that would no longer be selectable to complete the word entry can be indicated as not being selectable. For example, on-screen keyboard 306 includes letters 322 that are shown as “grayed-out” to indicate they are not selectable. However, any form of indication can be implemented to indicate the selectable status of particular letters in an on-screen keyboard.

At block 410, user input(s) are received to navigate the on-screen keyboard and position a focus to select the letters for on-screen text entry. For example, a user can navigate the on-screen keyboard 108 with user inputs via the game controller 104 and position the focus 114 to select letters for on-screen text entry. The selected inputs field 116 on the graphical user interface 110 shows the selected letters of a text entry. Further, a user can navigate the on-screen keyboard 210 (FIG. 2) with user inputs via the selectable controls 206 of the remote control device 204 and position the focus 214 to select letters for on-screen text entry. The selected inputs field 216 on the graphical user interface 212 shows the selected letters of a text entry.

Optionally at block 412, a time delay is initiated between successive user inputs. For example, the keyboard module 122 can be implemented to initiate a time delay between successive user inputs such that a user can select the same letter twice or move the focus to select another letter, or such that the keyboard module automatically repositions the focus 114 back to the most frequently used letter in the center of the on-screen keyboard 108. In this embodiment, a user can select a letter and rather than the focus automatically repositioning back to the center letter, the user can move the focus within the time delay period to another letter such that the focus does not reposition.

Optionally at block 414, the focus is repositioned back on the most frequently used letter in the on-screen keyboard after a letter has been selected. For example, the keyboard module 122 can be implemented to automatically reposition the focus 114 back to the most frequently used letter in the center of the on-screen keyboard 108 (e.g., after the time delay at block 412).

Optionally at block 416, the focus is positioned on a next most likely letter in the on-screen keyboard after a letter has been selected. For example, the keyboard module 314 can be implemented to position the focus 316 on the letter “U” at 326 after a user has selected the letter “Q” because the letter “U” often follows “Q” in English language words. Any number or combination of the described method blocks 402-416 can be combined to implement the various embodiments of an on-screen keyboard as described herein.

FIG. 5 illustrates various components of an example computer-based device 500 that can be implemented as any form of a computing, electronic, appliance, or television client device to implement embodiments of an on-screen keyboard. For example, computer device 500 can be implemented as the computer-based device 102 shown in FIG. 1, the television client device 202 shown in FIG. 2, or as the portable device 302 shown in FIG. 3. In various embodiments, computer device 500 can be implemented as any one or combination of a television client device, a desktop computer, a portable computer, an appliance device, a gaming console, and/or as any other type of computing-based device.

Computer device 500 includes one or more media content inputs 502 that may include Internet Protocol (IP) inputs over which streams of media content are received via an IP-based network. Computer device 500 further includes communication interface(s) 504 that can be implemented as any one or more of a serial and/or parallel interface, a wireless interface, any type of network interface, a modem, and as any other type of communication interface. A network interface provides a connection between computer device 500 and a communication network by which other electronic and computing devices can communicate data with device 500. Similarly, a serial and/or parallel interface provides for data communication directly between computer device 500 and the other electronic or computing devices. A modem facilitates computer device 500 communication with other electronic and computing devices via a conventional telephone line, a DSL connection, cable, and/or other type of connection.

Computer device 500 also includes one or more processors 506 (e.g., any of microprocessors, controllers, and the like) which process various computer-executable instructions to control the operation of device 500, to communicate with other electronic and computing devices, and to implement embodiments of an on-screen keyboard. Computer device 500 can be implemented with computer-readable media 508, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer-readable media 508 provides data storage mechanisms to store media content 510 as well as other information and/or data such as software applications and any other types of information and data related to operational aspects of computer device 500. For example, an operating system 512 and/or other computer applications 514 can be maintained as software applications with the computer-readable media 508 and executed on processor(s) 506 to implement embodiments of an on-screen keyboard. Computer device 500 can also include a keyboard module 516 (shown as a software module in this example) to implement various embodiments of an on-screen keyboard as described herein. Examples of the keyboard module 516 are described with reference to keyboard modules 122, 228, and 314 shown in FIGS. 1-3.

When implemented as a television client device, the computer device 500 can also include a DVR system 518 with playback application 520, and recording media 522 to maintain recorded media content 524 that computer device 500 receives and/or records. Further, computer device 500 may access or receive additional recorded media content that is maintained with a remote data store (not shown). Computer device 500 may also receive media content from a video-on-demand server, or media content that is maintained at a broadcast center or content distributor that distributes the media content to subscriber sites and client devices. The playback application 520 can be implemented as a video control application to control the playback of media content 510, the recorded media content 524, and/or other video on-demand media content, music, and any other audio, video, and/or image media content which can be rendered and/or displayed for viewing.

Computer device 500 also includes an audio and/or video output 526 that provides audio and/or video data to an audio rendering and/or display system 528. The audio rendering and/or display system 528 can include any devices that process, display, and/or otherwise render audio, video, and image data. Video signals and audio signals can be communicated from computer device 500 to a display device 530 via an RF (Radio Frequency) link, S-video link, composite video link, component video link, DVI (Digital Video Interface), HDMI (High Definition Multimedia Interface), analog audio connection, or other similar communication link. Alternatively, the audio rendering and/or display system 528 can be implemented as integrated components of the example computer device 500.

Although embodiments of an on-screen keyboard have been described in language specific to features and/or methods, it is to be understood that the subject of the appended claims is not necessarily limited to the specific features or methods described. Rather, the specific features and methods are disclosed as example implementations of an on-screen keyboard.

1. A method, comprising:
displaying an on-screen keyboard of letters arranged for user selection based on a frequency of the letters that are used most often, the letters being arranged around a centered letter that is the most often used; and
receiving user inputs to navigate the on-screen keyboard and position a focus to select the letters for on-screen text entry.

2. A method as recited in claim 1, wherein the on-screen keyboard is displayed to include the letters of an alphabet for a language, the letters being arranged for user selection based on the frequency of the letters that appear most often in words of the language.

3. A method as recited in claim 1, wherein the on-screen keyboard is displayed to include the letters of words used in a profession, the letters being arranged for user selection based on the frequency of the letters that appear most often in the words of the profession.

4. A method as recited in claim 1, wherein the on-screen keyboard is further displayed to include numbers arranged for user selection based on a frequency of the numbers that are used most often.

5. A method as recited in claim 1, wherein the on-screen keyboard is further displayed to include user-selectable controls that facilitate the on-screen text entry.

6. A method as recited in claim 1, wherein the on-screen keyboard is further displayed to include letters that are not selectable based on one or more selected letters and known words.

7. A method as recited in claim 1, further comprising initiating a time delay between successive user inputs for at least one of selecting the same letter twice, selecting another letter, or repositioning the focus back to the most frequently used letter in the on-screen keyboard after a letter has been selected.

8. An on-screen keyboard system, comprising:
a keyboard module configured to generate an on-screen keyboard for display on a graphical user interface, the on-screen keyboard including letters arranged for selection based on a frequency of the letters that are used most often, where the letters are arranged around a centered letter that is the most often used; and
an input device configured to facilitate navigating the on-screen keyboard to position a focus to select the letters.

9. An on-screen keyboard system as recited in claim 8, wherein the keyboard module is further configured to generate the on-screen keyboard to include the letters of an alphabet for a language, and wherein the letters are arranged for selection based on the frequency of the letters that appear most often in words of the language.

10. An on-screen keyboard system as recited in claim 8, wherein the keyboard module is further configured to generate the on-screen keyboard to include the letters of words used in a profession, and wherein the letters are arranged for selection based on the frequency of the letters that appear most often in the words of the profession.

11. An on-screen keyboard system as recited in claim 8, wherein the keyboard module is further configured to generate the on-screen keyboard to include numbers arranged for selection based on a frequency of the numbers that are used most often.

12. An on-screen keyboard system as recited in claim 8, wherein the keyboard module is further configured to initiate a time delay between successive letter selections for at least one of selecting the same letter twice, moving the focus to another letter, or repositioning the focus back on the most frequently used letter in the on-screen keyboard.

13. An on-screen keyboard system as recited in claim 8, wherein the keyboard module is further configured to initiate repositioning the focus back to the most frequently used letter in the on-screen keyboard after a letter has been selected.

14. An on-screen keyboard system as recited in claim 8, wherein the keyboard module is further configured to initiate positioning the focus on a next most likely letter in the on-screen keyboard after a letter has been selected.

15. Computer-readable media encoded with computer-executable instructions that, when executed, display a graphical user interface, comprising:
an on-screen keyboard that includes letters arranged for selection based on a frequency of the letters that are used most often, the letters being arranged around a centered letter that is the most often used; and
a selected inputs field that displays an on-screen text entry of selected letters.

16. Computer-readable media as recited in claim 15, further encoded with computer-executable instructions that, when executed, displays the graphical user interface comprising the on-screen keyboard that includes the letters of an alphabet for a language, the letters being arranged for selection based on the frequency of the letters that appear most often in words of the language.

17. Computer-readable media as recited in claim 15, further encoded with computer-executable instructions that, when executed, displays the graphical user interface comprising the on-screen keyboard that includes the letters of words used in a profession, the letters being arranged for selection based on the frequency of the letters that appear most often in the words of the profession.

18. Computer-readable media as recited in claim 15, further encoded with computer-executable instructions that, when executed, displays the graphical user interface comprising the on-screen keyboard that includes numbers arranged for selection based on a frequency of the numbers that are used most often.

19. Computer-readable media as recited in claim 15, further encoded with computer-executable instructions that, when executed, displays the graphical user interface comprising an on-screen focus that is repositioned back to the most frequently used letter in the on-screen keyboard after a letter has been selected.

20. Computer-readable media as recited in claim 15, further encoded with computer-executable instructions that, when executed, displays the graphical user interface comprising an on-screen focus that is positioned on a next most likely letter in the on-screen keyboard after a letter has been selected.
